(19) United States
(12) Patent Application Publication
(10) Pub. No.: US 2010/0241684 A1
(43) Pub. Date: Sep. 23, 2010

(54) OARCHITECTURES FOR SUPPORTING DIVERSE CLIENT TYPES IN TRANSACTIONAL SYSTEMS

(75) Inventors: Yu Cheng, Newcastle, WA (US); Kaifeng Yao, Beijing (CN); Wenwu Zhu, Basking Ridge, NJ (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/405,259

(22) Filed: Mar. 17, 2009

(51) Int. Cl. G06F 15/16; G06Q 99/00

(52) U.S. Cl. 709/202; 709/203; 709/206; 709/230; 705/1.1

(57) ABSTRACT

Architectures for supporting diverse client types in transactional systems are provided. These architectures provide computer-based systems that include any number of processors. These systems may also include computer-readable storage media that provide a transaction assistant module. In turn, the transaction assistant module may include an adaptive presentation layer and a shared logic layer. The adaptive presentation layer includes presentation components that correspond respectively to various types of client devices. The shared logic layer includes back-end components that are shared between the client devices to perform common functions on behalf of the client devices.

### BACKGROUND

Global communications networks continue to proliferate, and are increasingly becoming more accessible to more users around the world. Paralleling the growth in these communications networks, personal communications devices operating over these communications networks are also experiencing increased adoption and use. These personal communications devices are marketed by a variety of different vendors and manufacturers, and may operate under any number of different communication protocols. Thus, different personal communications devices may have different configurations and performance capabilities. In addition, the communications networks themselves may have different capabilities and capacities in different geographic locations.

### SUMMARY

Architectures for supporting diverse client types in transactional systems are provided. These architectures provide computer-based systems that include any number of processors. These systems may also include computer-readable storage media that provide a transaction assistant module. In turn, the transaction assistant module may include an adaptive presentation layer and a shared logic layer. The adaptive presentation layer includes presentation components that correspond respectively to various types of client devices. The shared logic layer includes back-end components that are shared between the client devices to perform common functions on behalf of the client devices.

It should be appreciated that the above-described subject matter may be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a combined block and flow diagram illustrating systems or operating environments suitable for implementing architectures for supporting diverse client types in transactional systems, featuring scenarios in which software components are installed locally on client devices.

FIG. 2 is a combined block and flow diagram illustrating additional architectures for supporting diverse client types in transactional systems, featuring scenarios in which the client devices operate browsers for interacting with server systems.

FIG. 3 is a combined block and flow diagram illustrating components and data flows involve with processing requests from the client devices, as facilitated by the architectures for supporting diverse client types in transactional systems.

FIG. 4 is a combined block and flow diagram illustrating additional components and process flows supported by an adaptive presentation layer and shared logic layer, as illustrated in FIG. 3.

FIG. 5 is a combined block and flow diagram illustrating components and data flows associated with a recommendation engine provided by the shared logic layer illustrated in FIGS. 3 and 4.

FIG. 6 is a combined block and flow diagram illustrating a portfolio manager component operating with the recommendation engine shown in FIG. 5.

FIG. 7 is a block diagram that illustrates further details of a social engine component as shown in FIG. 4.

FIG. 8 is a combined block and flow diagram that illustrates further details of a search engine component as shown in FIG. 4.

FIG. 9 is a flow chart illustrating process flows facilitated by the architectures for supporting diverse client types in transactional systems.

FIG. 10 is a flow chart illustrating additional process flows facilitated by the architectures for supporting diverse client types in transactional systems.

### DETAILED DESCRIPTION

The following detailed description provides tools and techniques for architectures for supporting diverse client types in transactional systems. While the subject matter described herein presents a general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

The following detailed description refers to the accompanying drawings that form a part hereof, and that show, by way of illustration, specific example implementations. Referring now to the drawings, in which like numerals represent like elements through the several figures, this description provides various tools and techniques related to architectures for supporting diverse client types in transactional systems.

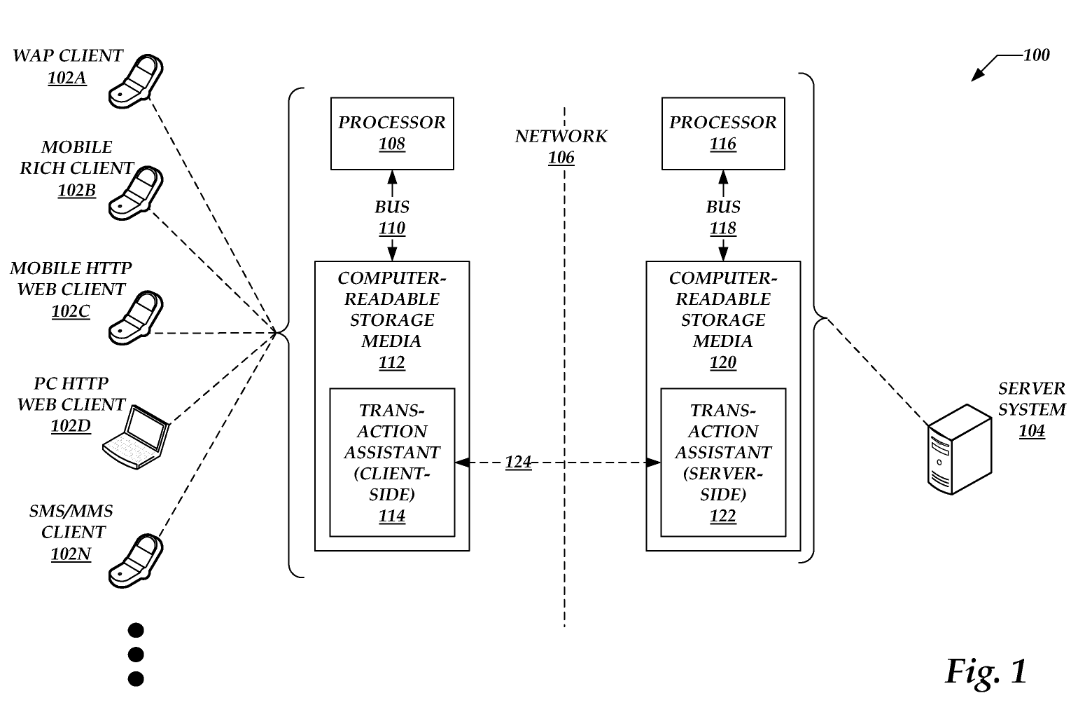

FIG. 1 illustrates systems or operating environments, denoted generally at 100, related to architectures for supporting diverse client types in transactional systems. Turning to FIG. 1 in more detail, these systems 100 may support any number of client devices, with FIG. 1 illustrating example client devices 102a-102n (collectively, client devices 102). Turning to the client devices 102 in more detail, the client devices 102a may represent mobile wireless communications devices that operate according to the Wireless Application Protocol (WAP), as defined by the WAP standard. Those skilled in the art are familiar with the WAP standard, and the WAP standards are therefore not discussed in further detail here.

The client devices 102b may represent mobile wireless communications devices that install particular software components provided in connection with the architectures for supporting diverse client types in transactional systems. Accordingly, this description refers to the client devices 102b, without limiting possible implementations, as a mobile rich client.

The client devices 102c may represent mobile wireless communications devices that operate according to the Hypertext Transfer Protocol (HTTP), as defined by applicable standards. Those skilled in the art are familiar with the applicable HTTP standards, and these HTTP standards are therefore not discussed in further detail here.

The client devices 102d may represent stationary or mobile computing devices that operate according to HTTP, as defined by applicable standards. Examples of the client devices 102d may include desktop personal computers (PCs), various mobile laptop or notebook computing systems, and the like. Those skilled in the art are familiar with the applicable HTTP standards, and these HTTP standards are therefore not discussed in further detail here.

The client devices 102n may represent mobile wireless communication devices that operate according to communication protocols, such as the Short Message Service (SMS) protocol, the Multimedia Messaging Service (MMS), or the like. In general, the client devices 102n may transmit and receive text-based communications, according to the SMS, MMS, or other suitable communications protocols.

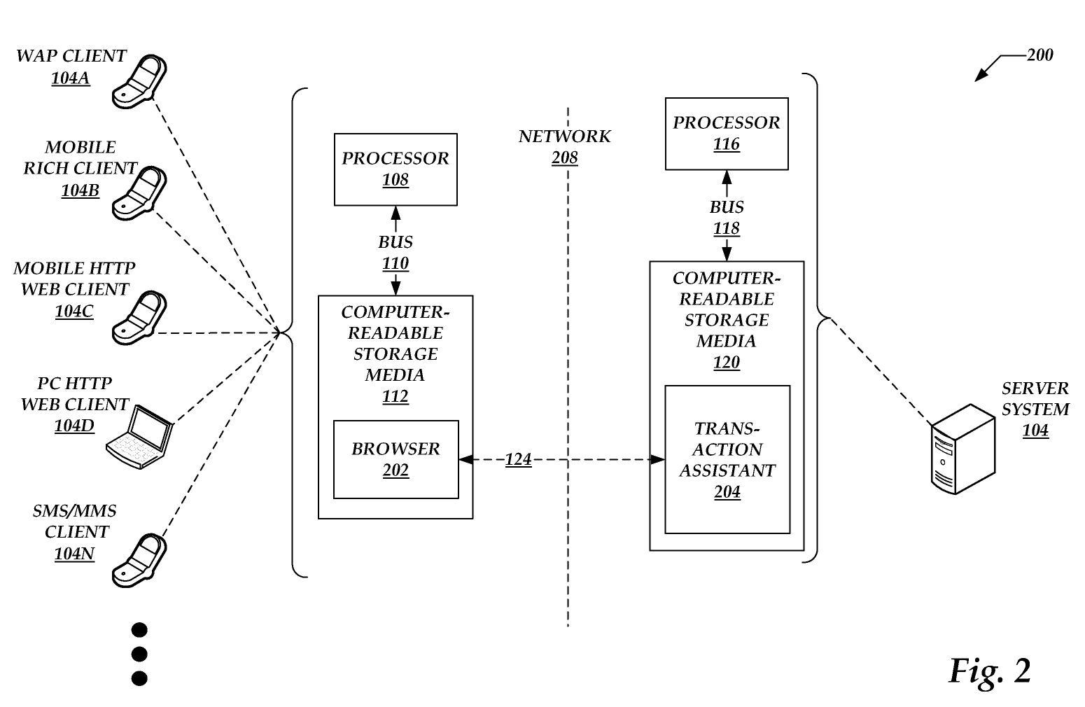

In general, the client devices 102 may communicate with one or more server systems 104, as facilitated by the architectures for supporting diverse client types in transactional systems. In some implementations, the client devices 102 may install software or other components locally, with the software or other components enabling the client devices 102 to cooperate with the server systems 104. In other implementations, the client devices 102 may remain unchanged, and not install software or other components locally on the client systems 102. In these latter implementations, the client devices 102 may include browser software or other similar components to communicate with the server systems 104. FIG. 1 illustrates examples of the former implementations, while FIG. 2 illustrates examples of the latter implementations.

As shown in FIGS. 1 and 2, the client devices 102 and the server systems 104 may communicate over one or more intermediate communications networks 106. Turning to the networks 106 in more detail, these networks 106 may represent any number of communications networks. For example, the networks 106 may represent local area networks (LANs), wide area networks (WANs), and/or personal area networks (e.g., Bluetooth-type networks), any of which may operate alone or in combination to facilitate operation of the tools and techniques provided in this description. The networks 106 as shown in FIG. 1 also represents any hardware (e.g., adapters, interfaces, cables, and the like), software, or firmware associated with implementing these networks, and may also represent any protocols by which these networks may operate.

Turning to the client devices 102 in more detail, these devices may include one or more processors 108, which may have a particular type or architecture, chosen as appropriate for particular implementations. The processors 108 may couple to one or more bus systems 110, having type and/or architecture that is chosen for compatibility with the processors 108.

The client devices 102 may also include one or more instances of computer-readable storage medium or media 112, which couple to the bus systems 110. The bus systems 110 may enable the processors 108 to read code and/or data to/from the computer-readable storage media 112. The media 112 may represent apparatus in the form of storage elements that are implemented using any suitable technology, including but not limited to semiconductors, magnetic materials, optics, or the like. The media 112 may include memory components, whether classified as RAM, ROM, flash, or other types, and may also represent hard disk drives.

The storage media 112 may include one or more modules of software instructions that, when loaded into the processor 108 and executed, cause the client devices 102 to perform various techniques provided herein in connection with the architectures for supporting diverse client types in transactional systems. As detailed throughout this description, these modules of instructions may also provide various tools or techniques by which the client devices 102 may participate within the systems 100 using the components, flows, and data structures discussed in more detail throughout this description. For example, the storage media 112 may include one or more software modules that implement client-side transaction assistant components 114.

In general, the client-side transaction assistant components 114 may, when loaded into the processors 108 and executed, transform the processors 108 and the overall client devices 102 from general-purpose computing systems into special-purpose computing systems. More specifically, these special-purpose computing systems may be adapted to cooperate with the architectures for supporting diverse client types in transactional systems.

Turning to the server systems 104 in more detail, these server systems 104 may include one or more processors 116, which may have a particular type or architecture, chosen as appropriate for particular implementations. The processors 116 may or may not be of the same type and architecture as the processors 108. The processors 116 may couple to one or more bus systems 118, having type and/or architecture that is chosen for compatibility with the processors 116. The bus systems 118 may or may not have the same type and architecture as the bus systems 110.

The server systems 104 may also include one or more instances of computer-readable storage medium or media 120, which couple to the bus systems 118. The bus systems 118 may enable the processors 116 to read code and/or data to/from the computer-readable storage media 120. The media 120 may represent apparatus in the form of storage elements that are implemented using any suitable technology, including but not limited to semiconductors, magnetic materials, optics, or the like. The media 120 may include memory components, whether classified as RAM, ROM, flash, or other types, and may also represent hard disk drives.

The storage media 120 may include one or more modules of software instructions that, when loaded into the processor 116 and executed, cause the server systems 104 to perform various techniques provided herein in connection with the architectures for supporting diverse client types in transactional systems. As detailed throughout this description, these modules of instructions may also provide various tools or techniques by which the server systems 104 may participate within the systems 100 using the components, flows, and data structures discussed in more detail throughout this description. For example, the storage media 120 may include one or more software modules that implement server-side transaction assistant components 122.

In general, the server-side transaction assistant components 122 may, when loaded into the processors 116 and executed, transform the processors 116 and the overall server systems 104 from general-purpose computing systems into special-purpose computing systems. More specifically, these special-purpose computing systems may be adapted to cooperate with the architectures for supporting diverse client types in transactional systems.

FIG. 1 represents at 124 command and/or data flows exchanged between the client devices 102 and the server systems 104, in connection with the architectures for supporting diverse client types in transactional systems. As described in further detail below, these command and/or data flows 124 may include requests originating from the client devices 102, and responses to those requests provided by the server systems 104.

FIG. 2 illustrates additional architectures for supporting diverse client types in transactional systems. More specifically, FIG. 2 illustrates systems or operating environments, denoted generally at 200, in which the client devices 102a-102n operate general-purpose browser software 202. In example scenarios, the browser software 202 may enable users associated with the client devices 102 to interact with the server systems 104. For example, the server systems 104 may send executable code to the client devices 102 for execution within the browser software 202.

The browser software 202 as shown in FIG. 2 is distinguished from the client-side transaction assistant 114 shown in FIG. 1. More specifically, the browser software 202 is general-purpose in nature, while the client-side transaction assistant 114 is adapted specifically for the architectures described herein for supporting diverse client types in transactional systems. In FIG. 1, certain processing described herein is distributed between the client-side transaction assistant 114 and the server-side transaction assistant 122. In FIG. 2, the processing described herein is performed primarily by a server-side shopping assistant 204, which may interact with the router component 202 on the client devices 102.

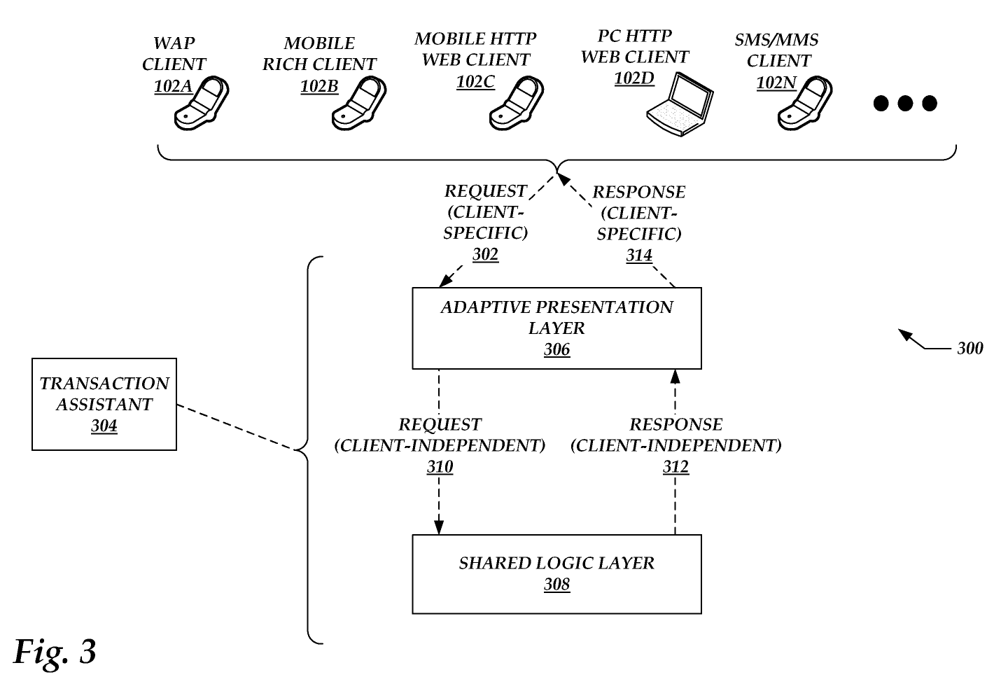

FIG. 3 illustrates components and data flows, denoted generally at 300, involved with processing requests 302 from the client devices 102a-102n, as facilitated by the architectures for supporting diverse client types in transactional systems. Without limiting possible implementations, FIG. 3 may be understood as elaborating further on the server-side transaction assistant 122 (as shown in FIG. 1) and/or the server-side transaction assistant 204 (as shown in FIG. 2). In FIG. 3, a transaction assistant 304 generally represents the transaction assistants 122 and 204.

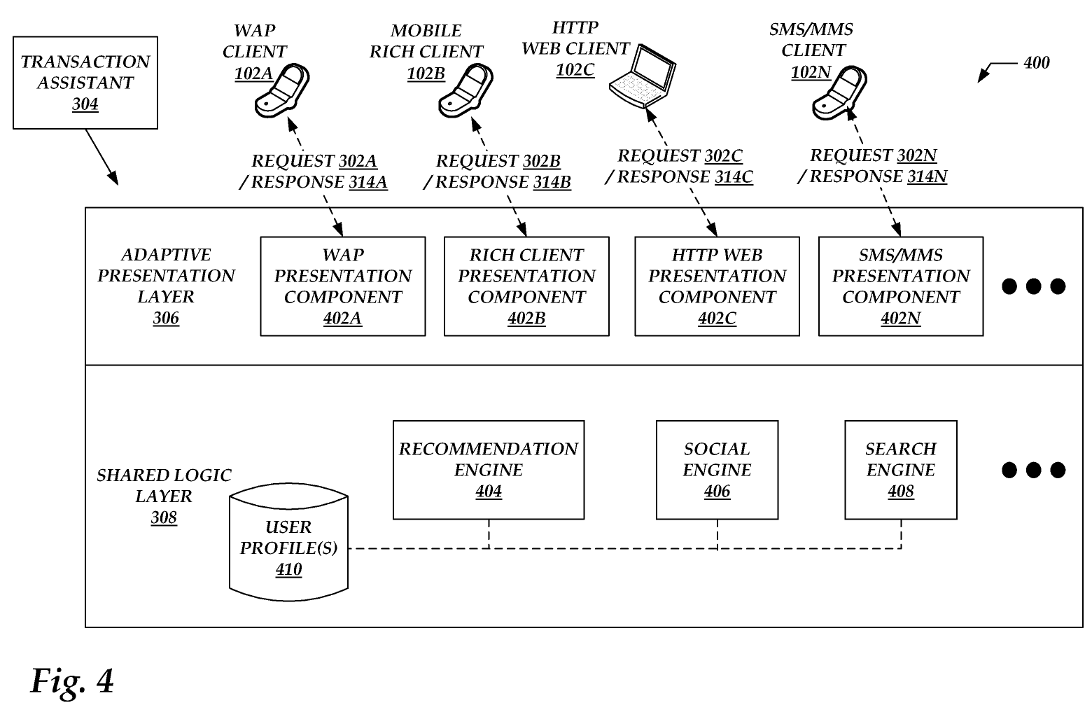

Turning to the transaction assistant 304 in more detail, it may generally include an adaptive presentation layer 306 and a shared logic layer 308. In general, the adaptive presentation layer 306 represents a collection of software components, with respective ones of these software components corresponding to different types of client devices 102a-102n. For example, FIG. 3 illustrates example implementations including several different types of client devices, denoted respectively at 102a-102n (collectively client devices 102). Accordingly, as described in further detail below with FIG. 4, the adaptive presentation layer 306 may include several different presentation components corresponding respectively to the different types of client devices 102. The adaptive presentation layer 306 is referred to herein as “adaptive” in the sense that the layer 306 enables the transaction assistant 304 to adapt to different types of client devices 102.

As shown above in FIG. 1, some implementations of the client devices 102 may install a client-side transaction component 114 to facilitate interaction with the server system 104. More specifically, the client-side transaction component 114 may include a layer of software that is deployed to the client devices 102. This layer of software may enable the client devices 102 to communicate with the adaptive presentation layer 306 on the server system 104.

Turning to the shared logic layer 308 in more detail, this layer 308 may provide any number of functions or capabilities made available to the client devices 102 through the presentation layer 306. FIG. 4 provides several examples of such functions or capabilities. However, in overview, the adaptive presentation layer 306 may receive any number of requests 302 from the client devices 102. In general, the requests 302 are specific to particular types of client devices 102. For example, if a given request 302 originates from the WAP client 102a, this given request 302 may comply with the WAP protocol. Accordingly, the given request 302 may be client-specific. However, the adaptive presentation layer 306 may translate or transform the client-specific request 302 into a client-independent request 310. More specifically, the client-independent request 310 may be uniform across any number of client devices 102.

In turn, the shared logic layer 308 may process the client-independent request 310, and return a client-independent response 312 that corresponds to the client-independent request 310. In implementations, the type and nature of the requests 310 and responses 312 may vary, depending on the type of capabilities or functions offered by the shared logic layer 308. FIG. 4 discussed below illustrates several non-limiting examples of such functions.

The shared logic layer 308 may return the client-independent response 312 to the adaptive presentation layer 306. In turn, the adaptive presentation layer 306 may transform or convert the client-independent response 312 into a client-specific response 314, depending on the type of the client 102 that originally submitted the request 302. For example, assuming that the WAP client 102a submits a given instance of the client specific request 302, the adaptive presentation layer 306 may transform a corresponding instance of the client-specific response 314 to comply with the WAP protocol recognized by the requesting WAP client 102a. Similar considerations apply to requests and responses submitted by other types of client devices represented at 102b-102n.

FIG. 4 illustrates more specific examples of components and process flows, denoted generally at 400, that the adaptive presentation layer 306 and the shared logic layer 308 may support. Examples of the adaptive presentation layer 306 and the shared logic layer 308 are carried forward from FIG. 3. Without limiting possible implementations, the components and process flows 400 shown in FIG. 4 may be understood as elaborating further on the transaction assistant software modules 304. FIG. 4 also carries forward examples of the different types of client devices, denoted at 102a-102n.

Turning to the adaptive presentation layer 306 in more detail, FIG. 4 illustrates examples in which the adaptive presentation layer 306 includes presentation components corresponding respectively to different types of client devices 102. For example, FIG. 4 depicts the WAP client 102a, the mobile rich client 102b, the HTTP Web client 102c, and the SMS/MMS client 102n. Accordingly, implementations illustrated in FIG. 4 may include a WAP presentation component 402a, which is operative to communicate with any WAP clients 102a included in a given implementation. A presentation component 402b may communicate with any rich clients 102b, while presentation component 402c communicates with any HTTP clients 102c. Finally, a presentation component 402n may communicate with any SMS/MMS clients 102n.

In general, the presentation components 402a-402n (collectively, presentation components 402) may operate to receive respective instances of requests and responses, associated respectively with different types of the client devices 102a 102n. More specifically, the WAP presentation component 402a may receive particular requests 302a from the WAP client 102a, and may provide responses 314a to those requests 302a. Likewise, the rich client presentation component 402b may receive particular requests 302b from the rich client 102b, and may provide responses 314b to those requests 302b. Similar considerations apply to the HTTP presentation component 402c and the SMS/MMS presentation component 402n, which may provide responses 314c and 314n respectively to incoming requests 302c and 302n.

Turning to the shared logic layer 308 in more detail, example implementations shown in FIG. 4 illustrates a recommendation engine 404, a social engine 406, and a search engine 408. The recommendation engine 404, the social engine 406, and the search engine 408 are described in further detail below with subsequent drawings figures. However, in overview, the recommendation engine 404 may be operative to receive certain requests 302a-302n (collectively, requests 302) that originate with different types of clients 102 and that are transformed by the adaptive presentation layer 306. Examples of these requests 302 may include recommendations for particular merchants of interest to users associated with the client devices 102. For example, these users may request recommendations for particular restaurants, clothing and apparel retailers, and other similar merchants. These examples are provided only for convenience in providing the present description, but do not limit possible implementations of this description. It is specifically noted that the tools and techniques described herein may be applied in a variety of different vertical industries, with restaurants and retailers provided only as examples.

In general, any back-end components (e.g., 404, 406, 408, etc.) included within the shared logic layer 308 may be shared among a plurality of client devices 102, even though the client devices 102 may be characterized as different types, and even though the client devices 102 may operate and communicate using different protocols. These back-end components within the shared logic layer 308 may thus provide a set of common functions made available or exposed to the client devices 102 through the adaptive presentation layer 306.

The shared logic layer 308 may include a set of storage elements containing user profiles 410, which may contain entries specifying preferences or other user-specific or device-specific information associated with particular users, or client devices 102 associated with such users. As described in further detail below, the user profiles 410 may cooperate with the recommendation engine 404, the social engine 406, and the search engine 408.

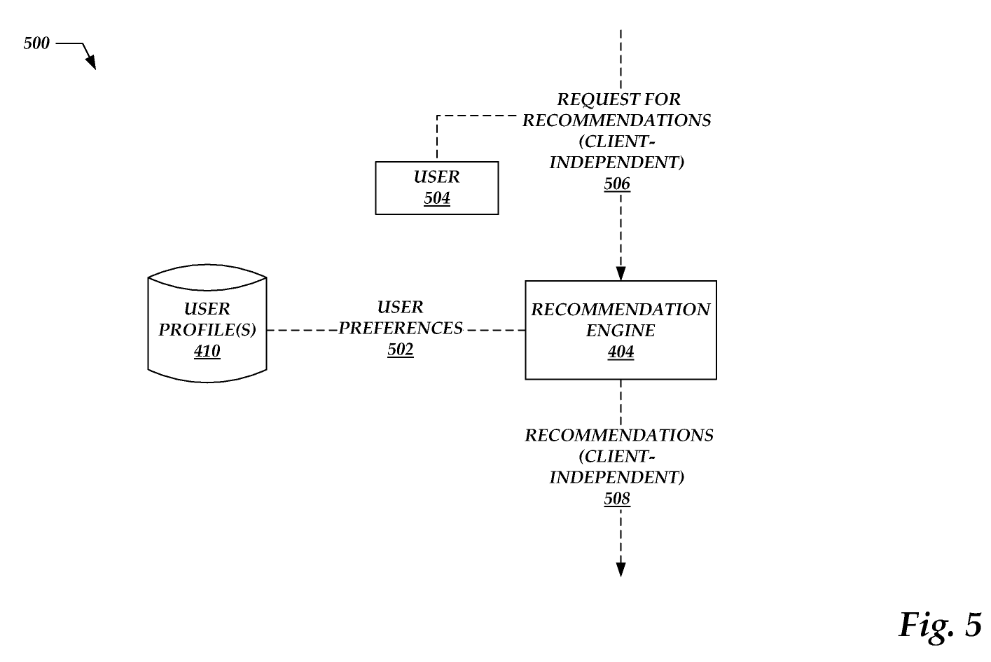

FIG. 5 illustrates components and data flows, denoted generally at 500, associated with the recommendation engine 404 provided by the shared logic layer 308 shown in FIGS. 3 and 4. Turning to the recommendation engine 404 in detail, FIG. 5 illustrates examples of the user preferences at 502. For example, the user preferences 502 may indicate particular cuisines or types of restaurants of interest to different users. Accordingly, when a given user 504 submits a request 506 for restaurant recommendations, the recommendation engine 404 may refer to the user profiles 410 for that given user to determine cuisines that the given user 504 prefers.

As described above, by the time that the incoming request 506 reaches the recommendation engine 404, the incoming request 506 is converted to a client-agnostic or client-independent format that is uniform across the shared logic layer 308. In turn, the recommendation engine 404 may return recommendations 508 in response to the incoming request 506. For example, if the given user 504 prefers Thai cuisine, and submits the request 506 from a given geographic location, the recommendations 508 may prioritize Thai restaurants close to the user's current geographic location.

Examples of the recommendations 508 may include information on particular merchants or other points of interest (e.g., restaurants, shops, tourist destinations, parks, and the like). In other scenarios, the recommendations 508 may pertain to other items of interest to users, with examples of such other items including travel arrangements, entertainment, multimedia, games, news, electronic book services, and the like. In some cases, the recommendations 508 may include coupons, discount offers, advertising materials, or other incentives for the users to consummate transactions.

In referring to geographic locations of client devices, it is noted that these geographic locations may be determined automatically, for example, using global positioning systems (GPSs), triangulation from cellular transmission towers, or other suitable techniques. In addition, users of the client devices may provide their locations manually (e.g., by entering a ZIP code, address, or the like).

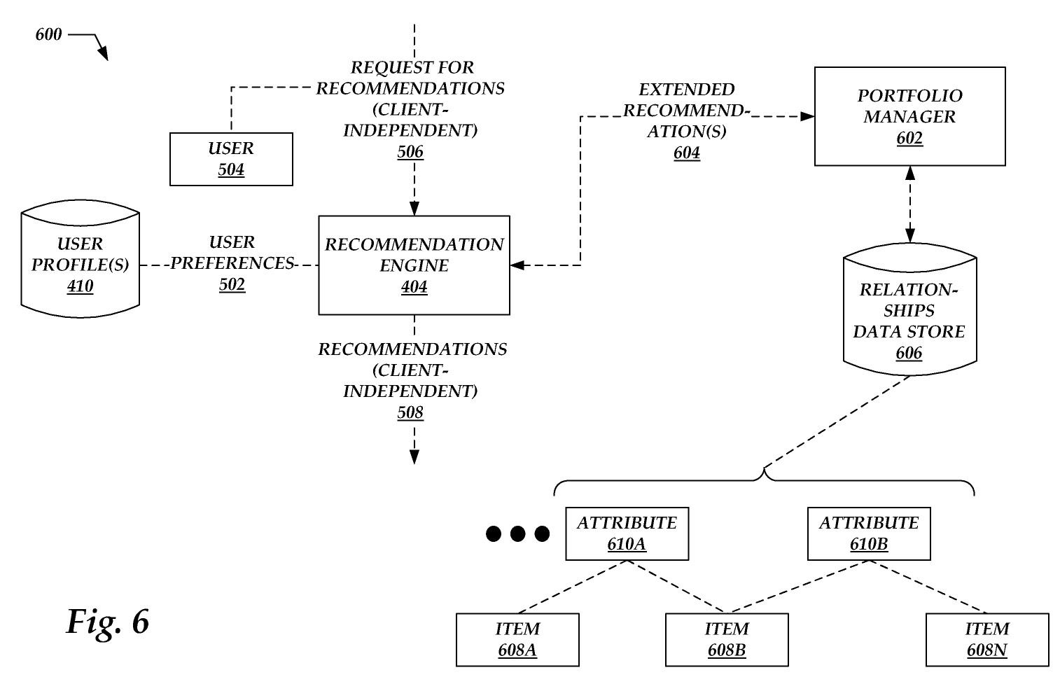

FIG. 6 illustrates extensions, denoted generally at 600, of the components and data flows shown in FIG. 5. More specifically, FIG. 6 illustrates software components 602 that serve as a portfolio manager. More specifically, the portfolio manager 602 may cooperate as described below with the recommendation engine 404, which is carried forward from FIG. 5.

Turning to the portfolio manager 602 in more detail, the portfolio manager 602 may provide extended recommendations 604 in response to one or more incoming requests 506. For example, if the user 504 submits a given incoming request 506 for restaurant recommendations, the user preferences 502 for that user 504 may indicate that the user 504 likes Thai cuisine. Accordingly, this may suggest that the user 504 enjoys cuisines that feature spicy recipes. The portfolio manager 602 may receive information indicating such user preferences, and may provide extended recommendations in light of such user preferences. For example, if the given user 504 likes Thai cuisine, the portfolio manager 602 may also recommend Korean restaurants in a given area, since Korean cuisine may also feature spicy recipes.

Generalizing the foregoing examples, the portfolio manager 602 may maintain a relationships status store 606, which contains representations of a variety of different relationships between different items having particular attributes. FIG. 6 provides example representations of such items at 608a, 608b, and 608n (collectively, item representations 608). Examples of these items 608 may include representations of particular merchants (e.g., Thai restaurants, Korean restaurants, or the like). In turn, these item representations 608 may be associated with particular attributes, with FIG. 6 providing examples of such attributes at 610a and 610b (collectively, attribute representations 610).

Returning to the restaurant example discussed above, if the item representation 608a corresponds to one or more Thai restaurants, and the item representation 608b corresponds to one or more Korean restaurants, the attribute represented at 610a may be common to Thai restaurants and Korean restaurants. For example, the attribute representations 610a may correspond to “spicy” cuisines. Accordingly, if the user preferences 502 associated with the given user 504 indicate a preference for Thai restaurants, the portfolio manager 602 may infer that the given user 504 likes spicy foods. For example, the portfolio manager 602 may perform this inference by identifying which of the item representations 608a-608n correspond to Thai restaurants, and then searching for some attribute 610a-610b associated with Thai restaurants.

Continuing the above example, within the relationships data store 606, if the item representation 608a is associated with Thai restaurants, and the attribute 610a is associated with spicy cuisines, then the portfolio manager 602 may traverse from the item representation 608a to the attribute representation 610a. From the attribute representation 610a, which corresponds to spicy cuisines, the portfolio manager 602 may identify any other item representations (e.g., 608b) that share the attribute represented at 610a (e.g., spiciness). Assuming that the other item representation 608b corresponds to Korean restaurants, the portfolio manager 602 may identify one or more Korean restaurants by traversing from the attribute representation 610a to the item representation 608b. Having identified these Korean restaurants, the portfolio manager 602 may include representations of these Korean restaurants in the extended recommendations 604. In turn, these extended recommendations 604 may be included in the client-independent recommendations 508 output from the recommendation engine 404.

Having provided the foregoing description of the recommendation engine 404 and the portfolio manager 602, several observations are noted. Over time, as different given users 504 interact more often with the recommendation engine 404, the recommendation engine 404 and/or the portfolio manager 602 may provide an increased level of personalization in the recommendations 508. For example, returning to the example discussed above in which Korean restaurants are included in the extended recommendations 604, if the given user 504 indicates interest in any recommended Korean restaurants, then the user preferences 502 may be updated to indicate that the given user 504 may be interested in recommendations to Korean restaurants in the future. Accordingly, the recommendation engine 404 may not only receive user preferences 502 from the user profile stores 410, but the recommendation engine may also update the user profile stores 410 with user preference information 502. Accordingly, the data flows represented by the dashed line 502 in FIGS. 5 and 6 may represent bidirectional data flows in possible implementations of this description.

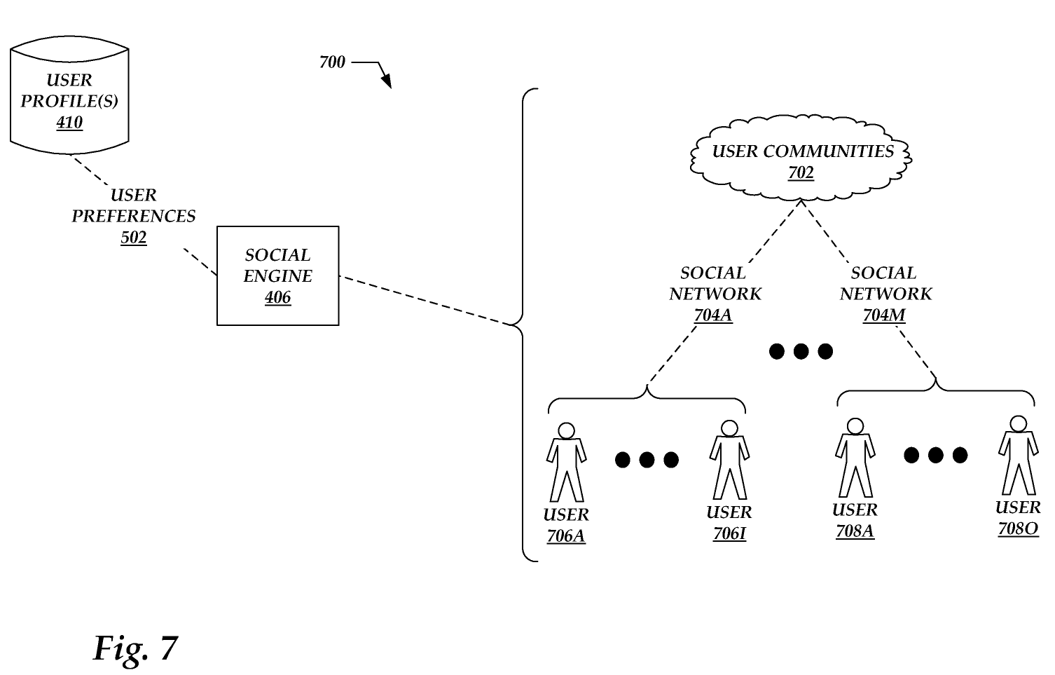

FIG. 7 illustrates further components and relationships, denoted generally at 700, related to the social engine component 406 as shown in FIG. 4. About limiting possible implementations, the components and relationships 700 may be understood as elaborating further on the social engine 406.

Turning to the social engine 406 in more detail, the social engine 406 may utilize user preference information stored within the user profiles 410. Without limiting possible implementations, FIG. 7 carries forward examples of the user profile store 410, and carries forward examples of the user preference information at 502.

Based at least on the user preference information 502, the social engine 406 may implement and support any number of user communities 702. In general, the user community 702 may include any number of social networks 704a and 704m (collectively, social networks 704). In general, the social network 704 may associate users with one another. For example, as shown in FIG. 7, the social network 704a may include any number of users 706a and 706i (collectively, users 706), and the social network 704m may include any number of users 708a and 708o (collectively, users 708). Typically, the users 706 in the social network 704a may share some degree of common interest in a given subject, while the users 708 in a social network 704m may share common interest in some other given subject. For example, the social network 704a may pertain to restaurant enthusiasts who prefer Thai cuisine, while the social network 704m may pertain to those who prefer French cuisine. However, implementations of this description may extend these examples to other scenarios without departing from the scope and spirit of this description.

Referring to the social network 704a, for example, those users 706 within the social network 704a may communicate with one another on any number of topics relating to their common or shared interests. For example, referring to the above example in which the social network 704a pertains to Thai restaurants, the users 706 may provide or share reviews of particular Thai restaurants in their respective areas. In addition, the users 706 may trade coupons, discounts, or other types of promotional materials with one another, where those discounts or promotional offers pertain to their areas of shared interest (e.g., Thai restaurants). In general, the foregoing descriptions and examples directed to the social networks 704a apply equally to these social networks 704m.

As appreciated from the foregoing description, the user communities 702 and the social network 704 may evolve over time. For example, different users 706 and 708 may join or leave the different social networks 704 over time. In addition, a given user may be a member of two or more social networks 704a and 704m.

The social engine 406 may also update the user profiles 410 for those users 706 and 708 who are members of the social networks 704. For example, these users 706 and 708 may provide preference information, whether explicitly or implicitly, through their interactions with other users within the social networks 704. In turn, the social engine 406 may provide updated user preference information 502 to the user profile stores 410. Afterwards, the recommendation engines 406 and/or the portfolio managers 602 may obtain these updated user preferences 502 from the user profiles 410. In turn, the recommendation engines 406 and/or the portfolio managers 602 may formulate their recommendations for different users based on these updated user preferences 502.

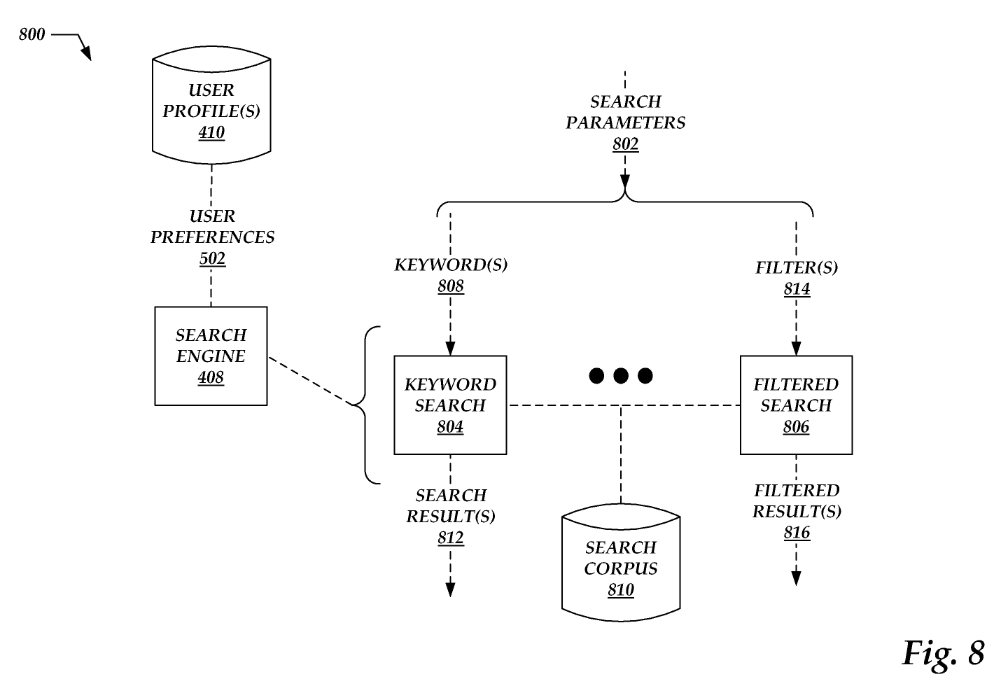

FIG. 8 illustrates components and process flows, denoted generally at 800, of the search engine component 408 as shown in FIG. 4. Without limiting possible implementations, the components and process flows 800 shown in FIG. 8 may be understood as elaborating further on the search engine component 408. In addition, FIG. 8 carries forward examples of the user profiles 410 and user preferences 502.

In general, the search engine 408 may operate by receiving search parameters, denoted generally at 802. In different possible implementations scenarios, the search engine 408 may provide keyword searching functions, denoted generally at 804, as well as providing filtered search capabilities, denoted generally at 806.

Turning more specifically to the keyword searching functions 804, incoming requests (e.g., 302 in FIG. 3) from the client devices 102 may specify one or more keywords relevant to subject matter of interest to one or more given users. For example, if a given user wishes to locate pizzerias, the user may enter the keyword “pizza” into his or her client device 102. In turn, the client device 102 may formulate and send a suitable request 302. The transaction assistant 304 may route the request 302 to the search engine 408, with the transaction assistant 304 incorporating the keywords provided by the user into the search parameters 802. In turn, the keyword searching functions 804 may search within a search corpus 810 for any occurrences of the keywords 808, and may return any occurrences of the keywords 808 as search results 812. The search corpus 810 may include, for example, representations of restaurants, clothing and apparel retailers, and the like, as may be loaded into the transaction assistant 304. However, these examples are understood as illustrative in nature, rather than limiting.

Referring now to the filtered search functions 806, the search parameters 802 may include any number of filters 814 specified by one or more given users via the client devices 102. For a given search request, the filters 814 may initially be null, such that all entries in the search corpus 810 may initially presented as filtered results 816. However, the user may then specify further filters 814, thereby narrowing the filtered results 816.

As a more concrete example of the foregoing, a given user may wish to locate a nearby Italian restaurant using the filtered search functions 806. Initially, the filters 814 may be null, resulting in all merchants represented in the search corpus 810 being included in the filtered results 816. However, the user may then specify “restaurants” as a filter 814, thereby narrowing the filtered results 816 to restaurants. The user may then specify “Italian cuisine” as another filter 814, thereby narrowing the filtered results 816 to “Italian restaurants”. Finally, the user may specify a geographic location as yet another filter 814, thereby narrowing the filtered results 816 to “Italian restaurants” that also satisfy the geographic filter. The user may then select from among the Italian restaurants presented in the filtered results 816.

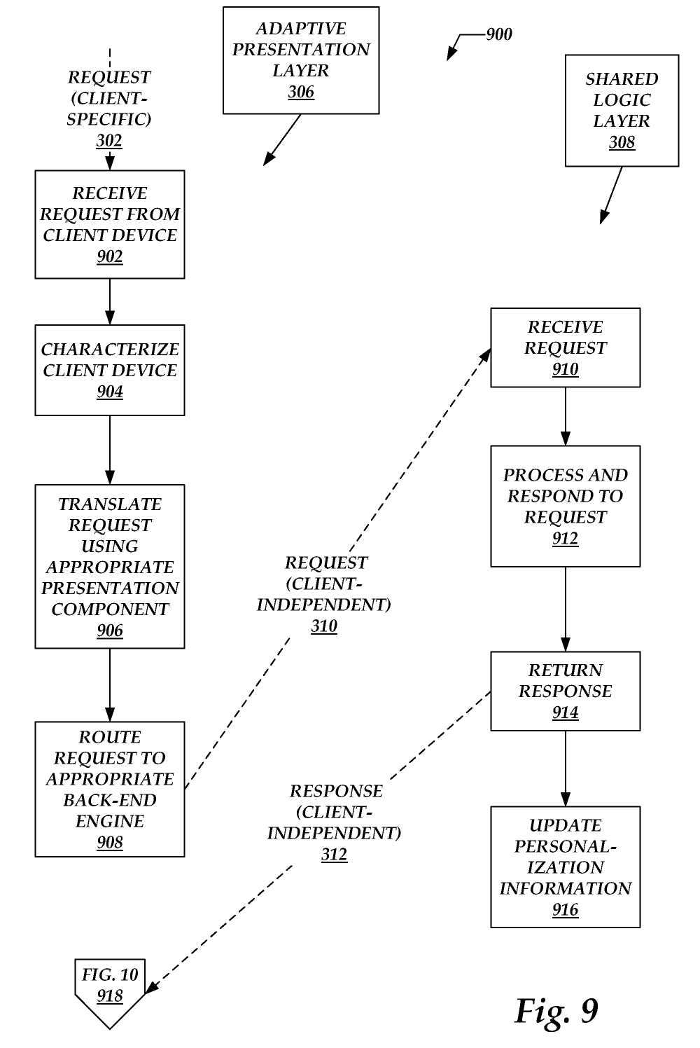

FIG. 9 illustrating process flows, denoted generally at 900, facilitated by the architectures for supporting diverse client types in transactional systems. For convenience of description, but not to limit possible implementations, the process flows 900 are shown as performed by the adaptive presentation layer 306 and the shared logic layer 308. However, the process flows 900 may be performed, at least in part, using components other than those shown in FIG. 9 without departing from the scope and spirit of the present description.

Turning to the process flows 900 in more detail, or specifically, the adaptive presentation layer 306, FIG. 9 carries forward an example client-specific request from FIG. 3, as indicated at 302. Block 302 represents receiving one or more client-specific requests from different client devices. Previous figures provide examples of client devices, as denoted at 102. In addition, examples of these requests may depend on the different types of functions offered by the shared logic layer 308. For example, the shared logic layer 308 as shown in FIG. 4 may provide one or more recommendation engines 404, social engines 406, search engines 408, as well as other functions not shown in FIG. 4.

Block 904 represents characterizing the client device (e.g., 102 in FIG. 1) from which the request received in block 302 originated. More specifically, block 904 may include determining a type associated with the client device that originated the request received in block 904. FIG. 1 illustrates various non-limiting examples of different types of client devices (e.g., WAP, rich clients, HTTP, SMS/MMS, etc.).

Block 906 represents translating the request received in block 902 using a presentation component suitable for the client device, as characterized in block 904. As described above in connection with FIGS. 3 and 4, the adaptive presentation layer 306 may include any number of presentation components, with different ones of the presentation components corresponding to different types of client devices. For example, referring briefly to FIG. 4, the adaptive presentation layer 306 may include the WAP presentation component 402a, which is adapted to interface with WAP client devices 102a. Similarly, the rich client presentation component 402b may interface with rich client devices 102b, and the HTTP Web presentation component 402c may interface with HTTP client devices 102c. Finally, the SMS/MMS presentation component 402n may interface with any SMS/MMS client devices 102n.

Block 906 may include translating an incoming client-specific request (e.g., 302) into a client-independent format that is uniform across any components provided by the shared logic layer 308. In this manner, the various opponents within the shared logic layer 308 may process a given request agnostically and without knowledge of what type of client originated the given request.

Block 908 represents routing the incoming request to an appropriate back-end engine provided by the shared logic layer 308. More specifically, block 908 may include routing the incoming request, as translated by block 906. In addition, block 908 may include analyzing the incoming request to determine the back-end engine to which that request should be routed. Referring briefly to FIG. 4, this figure provides examples in which the shared logic layer 308 includes the recommendation engine 404, the social engine 406, and the search engine 408. However, implementations of this description may include any of these illustrative engines, as well as other engines not specifically shown in FIG. 4.

Returning to FIG. 9, this figure carries forward from FIG. 3 an example client-independent request 310. As shown in FIG. 9, block 908 may include outputting the client-independent request 310 from the adaptive presentation layer 306 to the shared logic layer 308.

Turning to the shared logic layer 308, block 910 represents receiving the client-independent request 310 from block 908 in the adaptive presentation layer 306. In turn, block 912 represents processing and responding to the request received in block 910. More specifically, block 912 may include identifying an appropriate backend engine suitable for processing the request 310. For example, if the incoming request 310 is a search request, then block 912 may include directing the request 310 to the search engine 408. If the incoming request 310 is a request for recommendations, then block 912 may include directing the request 310 to the recommendation engine 404. Similarly, if the incoming request 310 is a request related to social networks maintained by the shared logic layer 308, then block 912 may include erecting the request 310 to the social engine 406. Similar considerations may apply to other types of back-end engines provided in different implementations of the shared logic layer 308.

Block 914 represents returning any response generated by the back-end engine to which the client-independent request 310 is routed. For example, block 914 may include returning any search results generated in response to a search request, recommendations generated in response to a request for recommendations, and the like. In implementations of this description, the responses returned by block 914 may vary, depending on the types of back-end engines provided by the shared logic layer 308.

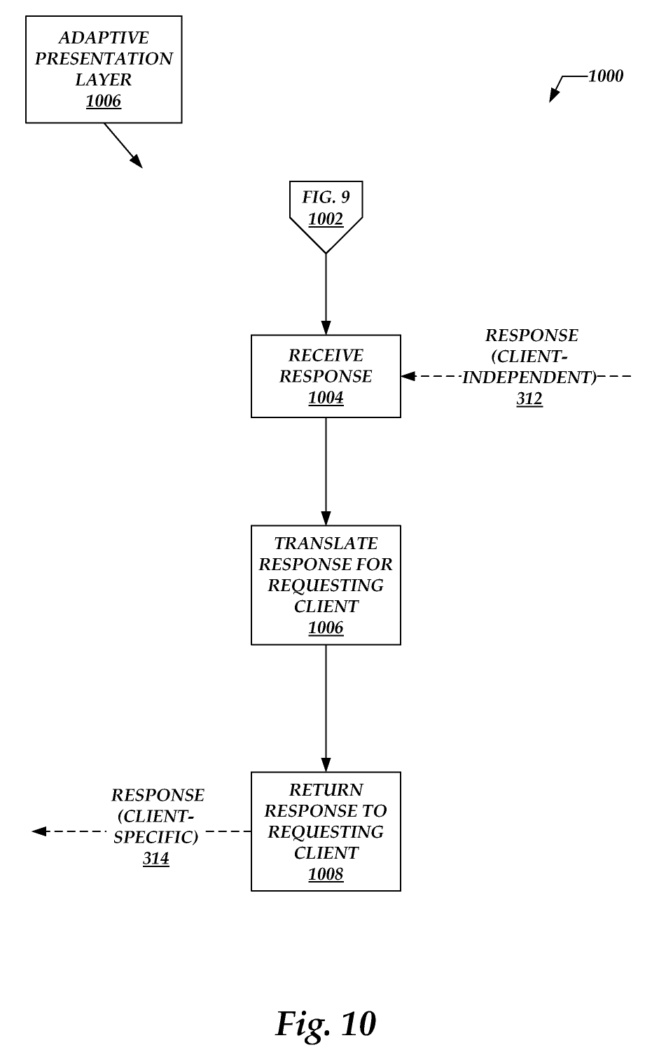

Block 914 may include returning a response, in a uniform, client-independent format, to the adaptive presentation layer 306. FIG. 9 carries forward from FIG. 3 an example of such a client-independent response at 312. For clarity of illustration, but not to limit possible implementations of this description, description of additional processing performed by the adaptive presentation layer 306 is continued shortly with FIG. 10.

As described above, the shared logic layer 308 may maintain user profiles 410, which may cooperate with various back-end software components also maintained by the shared logic layer 308. Examples of these back-end software components may include the recommendation engine 404, the social engine 406, the search engine 408, as well as other software components. These back-end software components may, in some cases, retrieve information related to particular users from the user profiles 410. However, in other cases, these back-end software components may update the user profiles 410 based on interactions with particular users. For example, if a given user submits a search request incorporating particular keywords, the search engine 408 may infer that these keywords represent subject matter of interest to that given user. Accordingly, the search engine 408 may update the user profile 410 with this information. Other examples of updating the user profile 410 are possible in different implementations.

In general, block 916 in FIG. 9 represents updating user information stored in the user profiles 410. More specifically, block 916 may include updating information stored in the user profiles 410 that may facilitate personalizing operation of the various back-end components for particular users. For example, referring back to the search scenario discussed in the previous paragraph, if the given user requests restaurant recommendations after having previously searched for Thai restaurants, the restaurant recommendations may be personalized to focus on Thai restaurants.

Returning to the adaptive presentation layer 306, further processing of the client-independent response 312 is continued in FIG. 10, via off-page reference 918. FIG. 10 illustrates additional process flows, denoted generally at 1000, facilitated by the architectures for supporting diverse client types in transactional systems. The description of FIG. 10 begins at off-page reference 1002, from FIG. 9. Without limiting possible implementations of this description, the process flows 1000 may be understood as elaborating further on the adaptive presentation layer 306.

Turning to the process flows 1000 in more detail, block 1004 represents receiving a client-independent response (e.g., 312). For example, lock 1004 may include receiving the client-independent response from the shared logic layer 308. As described previously, this client-independent response 312 may vary, depending on which back-end software components are included in the shared logic layer 308.

In general, the stored logic layer 308 provides the client-independent response 312 in response to an incoming request (e.g., 302 in FIG. 3) received from a client device characterized as having a particular type. Block 1006 represents transforming the client-independent response 312 received in block 1004, as appropriate for the client who originated the incoming request. For example, if the client-independent response is generated in reply to a request from a WAP client device (e.g., 102a in FIG. 1), then block 1006 may include transforming the client-independent response 312 into a format compatible with WAP. Similar considerations apply to any other client types supported by the adaptive presentation layer 306.

Block 1008 represents returning a client-specific response to the client that originated the request 302. For convenience, FIG. 10 carries forward an example client-specific response FIG. 3, as denoted at 314. Block 1004 may output the client-specific response 314, in block 1008 may return this client-specific response 314 to the requesting client.

The foregoing description provides architectures for supporting diverse client types in transactional systems. Although this description incorporates language specific to computer structural features, methodological acts, and computer readable media, the scope of the appended claims is not necessarily limited to the specific features, acts, or media described herein. Rather, this description provides illustrative, rather than limiting, implementations. Moreover, these implementations may modify and change various aspects of this description without departing from the true spirit and scope of this description, which is set forth in the following claims.

We claim:

1. A computer-based system comprising:
at least one processor;
at least one computer-readable storage medium coupled to communicate with the processor and having stored thereon computer-executable instructions that, when loaded into the processor and executed, transform the processor and cause the processor to
receive at least one request from at least one client device, wherein the request is specified in a client-specific format;
characterize the client device as having a type;
translate the request into a client-independent format that is uniform across a plurality of different client types;
rout the request to at least one of a plurality of software components for processing; and
process the request based on information specific to a user associated with the client device.

2. The computer-based system of claim 1, further comprising instructions to generate a response to the request, and to return the response in reply to the request.

3. The computer-based system of claim 2, further comprising instructions to translate the response into the client-specific format.

4. The computer-based system of claim 3, further comprising instructions to return the response to the client device in the client-specific format.

5. The computer-based system of claim 1, wherein the instructions to receive at least one request include instructions to receive a request for recommendations related to subject matter of interest to the user.

6. The computer-based system of claim 1, wherein the instructions to receive at least one request include instructions to receive a request to perform a search for subject matter of interest to the user.

7. The computer-based system of claim 1, wherein the instructions to receive at least one request include instructions to receive a request to interact with members of a social network that includes at least the user.

8. A computer-based system comprising:
at least one processor;
at least one computer-readable storage medium coupled to communicate with the processor and having stored thereon computer-executable instructions that provide
a transaction assistant module including an adaptive presentation layer and a shared logic layer;
wherein the adaptive presentation layer includes a plurality of presentation components that correspond respectively to a plurality of types of client devices; and
wherein the shared logic layer includes a plurality of back-end components shared between the client devices to perform common functions on behalf of the client devices.

9. The computer-based system of claim 8, further comprising at least one storage element containing user profile information associated with users of the client devices.

10. The computer-based system of claim 8, wherein the shared logic components include at least a social engine component that is operative to maintain representations of at least one community of users associated with the client devices.

11. The computer-based system of claim 10, wherein the social engine component is operative to maintain a plurality of social networks, wherein the social networks include representations of a plurality of the users.

12. The computer-based system of claim 8, wherein the shared logic components include at least a recommendation engine that is responsive to requests from users of the client devices to provide recommendations related to subjects of interest to the users.

13. The computer-based system of claim 12, wherein the recommendations comprise restaurant recommendations provided to particular users.

14. The computer-based system of claim 12, wherein the shared logic components include at least a portfolio manager coupled to communicate with the recommendation engine, wherein the portfolio manager is operative to provide extended recommendations to the recommendation engine, based at least on preference information associated with at least one user.

15. The computer-based system of claim 14, wherein the portfolio manager is operative to maintain a relationships data store that contains representations of a plurality of attributes, wherein the representations of the attributes are linked to representations of items that possess the attributes.

16. The computer-based system of claim 8, wherein the shared logic components include at least a search engine that is responsive to requests from users of the client devices to provide search results to the users.

17. The computer-based system of claim 16, wherein the search results are personalized to the users.

18. The computer-based system of claim 8, wherein the presentation components include at least a presentation component that is compatible with client devices that operate under the Wireless Application Protocol (WAP), the Hypertext Transfer Protocol (HTTP), the Multimedia Messaging Service (MMS), or the Short Message Service (SMS).

19. At least one computer-readable storage medium having stored thereon computer-executable instructions that, when loaded into the processor and executed, transform the processor and cause the processor to:
receive a plurality of requests from a plurality of client devices, wherein different ones of the client devices operate under different communication protocols, and wherein the requests are specified in a plurality of different formats specific to the communication protocols;
characterize the different client devices as having different types, based on the different communication protocols;
translate the different requests into a client-independent format that is uniform across the different client types;
route the requests to at least one of a plurality of software components for processing;
process the requests based on information specific to users associated with the client devices;
generate responses to the requests, based at least on preference information associated with users of the client devices, wherein the response are provided in the client-independent format;
translate a first one of the responses into a first client-specific format that is associated with a first one of the client devices;
translate at least a second one of the responses into a second client-specific format that is associated with a second one of the client devices;
return the first response to the first client device in the first client-specific format; and
return at least the second response to the second client device in the second client-specific format.

20. The computer-readable storage medium of claim 19, further comprising instruction to update the preference information associated with the users.
